(19) United States
(12) Patent Application Publication
(10) Pub. No.: US 2026/0160545 A1
(43) Pub. Date: Jun. 11, 2026

(54) FLUIDICALLY INNERVATED SENSORIZED STRUCTURES

(71) Applicant: Massachusetts Institute of Technology, Cambridge, MA (US)

(72) Inventors: Ryan L. Truby, Chicago, IL (US); Lillian T. Chin, Decatur, GA (US); Annan Zhang, Cambridge, MA (US); Daniela L. Rus, Weston, MA (US)

(73) Assignee: Massachusetts Institute of Technology, Cambridge, MA (US)

(21) Appl. No.: 18/709,589

(22) PCT Filed: Sep. 29, 2022
(86) PCT No.: PCT/US2022/045155

§ 371 Date: May 13, 2024

Related U.S. Application Data
(60) Provisional application No. 63/283,655, filed on Nov. 29, 2021.

(51) Int. Cl. G01B 13/24; B25J 13/08

(52) U.S. Cl. CPC G01B 13/24; B25J 13/081

(57) ABSTRACT

Architected materials are vascularized with air-filled channels, imbuing structures with fluidic sensing, actuation, and programmed mechanical behaviors.

### CROSS-REFERENCE TO RELATED APPLICATIONS

This application claims the benefit under 35 U.S.C. § 119 of U.S. Provisional Patent Application No. 63/283,655 filed on Nov. 29, 2021, which is hereby incorporated by reference herein in its entirety.

### STATEMENT REGARDING FEDERALLY SPONSORED RESEARCH

This invention was made with government support under EFMA-1830901 awarded by the National Science Foundation. The Government has certain rights in the invention.

### BACKGROUND

Multifunctionality is a defining feature in the composition and forms of biological systems. For example, the xylem of vascular plants participates in water and nutrient transport while directly contributing to structural integrity and resiliency. The hierarchical structure of skeletal muscles facilitates the innervation and vascularization of densely packed muscle fibers, fulfilling the actuation, proprioception, and metabolic needs of vertebrate locomotion. These materials and structures have evolved to address multiple needs in a single composite, enabling living organisms to efficiently achieve the performance required for their continued survival and evolutionary fitness. Inspired by these lessons, multifunctionality in materials design has increasingly been considered as a strategy to improve the performance, range of capabilities, and efficiency of a broad range of new technologies.

One class of multifunctional materials needed for a large subset of emerging technologies is materials with programmable mechanical properties and distributed sensing capabilities. See, e.g., M. A. McEvoy, N. Correll, “Materials that couple sensing, actuation, computation, and communication,” Science, 347, 1261689 (2015); G.-Z. Yang, J. Bellingham, P. E. Dupont, P. Fischer, L. Floridi, R. Full, N. Jacobstein, V. Kumar, M. McNutt, R. Merrifield, B. J. Nelson, B. Scassellati, M. Taddeo, R. Taylor, M. Veloso, Z. L. Wang, Robert Wood, “The grand challenges of science robotics,” Science Robotics, 3, eaar7650 (2018); C. Kaspar, B. J. Ravoo, W. G. van der Wiel, S. V. Wegner, W. H. P. Pernice, “The rise of intelligent matter. Nature,” 594, 345-355 (2021); and M. Kaur, T.-H. Kim, W. S. Kim, “New frontiers in 3D structural sensing robots,” Advanced Materials, 33, 2002534 (2021). Recent works have demonstrated that materials with intrinsic somatosensory capabilities akin to those of animals can potentially address key performance challenges in next-generation smart structures, wearable devices, prosthetics, e-textiles and apparel, and robotics. See, e.g., C. Larson, B. Peele, S. Li, S. Robinson, M. Totaro, L. Beccai, B. Mazzolai, R. Shepherd, “Highly stretchable electroluminescent skin for optical signaling and tactile sensing,” Science, 351, 1071-1074 (2016); R. L. Truby, M. Wehner, A. K. Grosskopf, D. M. Vogt, S. G. M. Uzel, R. J. Wood, J. A. Lewis, “Soft Somatosensitive Actuators via Embedded 3D Printing,” Advanced Materials, 30, 1706383 (2018); T. G. Thuruthel, B. Shih, C. Laschi, Michael Thomas Tolley, “Soft robot perception using embedded soft sensors and recurrent neural networks,” Science Robotics, 4, eaav1488 (2019); P. A. Xu, A. K. Mishra, H. Bai, C. A. Aubin, L. Zullo, R. F. Shepherd, “Optical lace for synthetic afferent neural networks,” Science Robotics, 4, eaaw6304 (2019); R. L. Truby, C. D. Santina, D. Rus, “Distributed Proprioception of 3D Configuration in Soft, Sensorized Robots via Deep Learning,” IEEE Robotics and Automation Letters, 5, 3299-3306 (2020); and “S. A. Manzano, P. Xu, K. Ly, R. Shepherd, N. Correll, “High-bandwidth nonlinear control for soft actuators with recursive network models” (2021).

### SUMMARY

It is appreciated herein that the materials used in applications such as smart structures, wearable devices, prosthetics, e-textiles and apparel, and robotics typically have strict mechanical requirements, such as high strength to weight ratios, extreme stiffness or compliance, and stretchability. These constraints make it difficult to imbue existing optimized materials with sensing. Indeed, current approaches to creating sensorized materials- and multifunctional materials in general—involve the integration of multiple materials, either through manual assembly or multi-material 3D printing. See, e.g., S. Li, H. Bai, R. F. Shepherd, H. Zhao, “Bio-inspired design and additive manufacturing of soft materials, machines, robots, and haptic interfaces,” Angewandte Chemie International Edition. 58, 11182-11204 (2019). These fabrication techniques involve specialized, low-throughput, and/or complex methods or equipment that are often limited in the materials they can assemble. Their limitations prevent both the desired mechanical and sensory needs from being met optimally.

Thus, while multifunctional materials with distributed sensing and programmed mechanical properties may benefit (or even be required for) myriad emerging technologies, current fabrication techniques constrain the design and sensing capabilities of such materials.

Motivated by these challenges, presented herein are techniques and strategies for fabricating multifunctional materials with programmable mechanical behaviors and distributed sensing capabilities by controlling the form of a single build material. Various embodiments involve the sensorization of architected materials via open fluidic networks and may be constructed via 3D printing. Architected materials are a class of materials that achieve tailorable mechanical properties entirely via geometry, as described in K. Bertoldi, V. Vitelli, J. Christensen, M. van Hecke, “Flexible mechanical metamaterials,” Nature Reviews Materials, 2, 17066 (2017). While this makes them excellent for achieving optimally programmed mechanical performance, architected materials' dependence on geometry makes them difficult to sensorize. The structures and techniques disclosed herein surmount this problem by embedding empty, air-filled fluidic networks directly into an architected material's internal structure. Once sealed, the networks' internal pressures can be measured as voltage signals during deformation and used as sensory feedback.

Cavity-based fluidic sensors have been developed for tactile feedback in robotic grippers with compliant fingertips and soft robotic tactile skins. See, e.g., J. Kim, A. Alspach, K. Yamane, in 2015 IEEE/RSJ international conference on intelligent robots and systems (IROS) (2015), pp. 2419-2425; L. He, Q. Lu, S.-A. Abad, N. Rojas, T. Nanayakkara, “Soft fingertips with tactile sensing and active deformation for robust grasping of delicate objects,” IEEE Robotics and Automation Letters, 5, 2714-2721 (2020); and A. M. Gruebele, M. A. Lin, D. Brouwer, S. Yuan, A. C. Zerbe, M. R. Cutkosky, “A Stretchable Tactile Sleeve for Reaching Into Cluttered Spaces,” IEEE Robotics and Automation Letters, 6, 5308-5315 (2021). However, prior methods rely on molding-based fabrication methods, yielding relatively large sensors that only provide tactile feedback.

By contrast, according to the present disclosure, sensors can be co-created with the structure via 3D printing, enabling them to be incorporated within more complex geometries and for more internal measurements. Likewise, the analog electronic feedback received from disclosed sensors is distinct from other types of soft fluidic sensors that provide solely binary mechanical feedback. For example, fluidic bistable valves have enabled an electronics-free approach to reflexive tactile sensing in soft robotic grippers that autonomously grasp upon contact with an object and untethered soft robots that autonomously reverse gait upon activation of the fluidic sensor with an obstruction like a wall. See P. Rothemund, A. Ainla, L. Belding, D. J. Preston, S. Kurihara, Z. Suo, George M. Whitesides, “A soft, bistable valve for autonomous control of soft actuators,” Science Robotics, 3, eaar7986 (2018); and D. Drotman, S. Jadhav, D. Sharp, C. Chan, Michael T. Tolley, “Electronics-free pneumatic circuits for controlling soft-legged robots,” Science Robotics, 6, eaay2627 (2021). Sensing feedback from such prior fluidic sensors are only compatible with fluidic logic-based controllers, while disclosed sensors can interface with traditional voltage-based controllers through a pressure transducer.

The concepts, structures, and techniques disclosed herein present three key opportunities. First, fluidic innervation provides a straightforward route for placing, distributing, and fabricating sensors within the sparse geometries of architected materials. Second, disclosed fluidic sensing strategies avoids the time-varying effects common to current soft sensors. Soft sensors based on conductive liquids, piezoresistive elastomers, and viscoelastic waveguides are susceptible to drift and hysteresis due to their underlying microstructures and/or physicochemical behaviors. See, e.g., S. Li, H. Bai, R. F. Shepherd, H. Zhao, “Bio-inspired design and additive manufacturing of soft materials, machines, robots, and haptic interfaces,” Angewandte Chemie International Edition. 58, 11182-11204 (2019). Disclosed fluidic sensing strategies avoid these issues by directly reading pressure changes of closed, deformable volumes patterned within the structure. Finally, disclosed techniques enable the creation of soft robotic systems with true somatosensory capabilities by using machine learning to associate sensor feedback with deformation for proprioception.

In addition, building off recent efforts to develop novel compliant materials for motorized soft robots, disclosed techniques can be used to sensorize a range of structures, including a group of materials called handed shearing auxetics (HSAs). See, e.g., J. I. Lipton, R. MacCurdy, Z. Manchester, L. Chin, D. Cellucci, D. Rus, “Handedness in shearing auxetics creates rigid and compliant structures,” Science, 360, 632-635 (2018); L. Chin, J. Lipton, R. MacCurdy, J. Romanishin, C. Sharma, D. Rus, in 2018 IEEE-RAS International Conference on Soft Robotics (RoboSoft) (2018); and R. L. Truby, L. Chin, D. Rus, “A Recipe for Electrically-Driven Soft Robots via 3D Printed Handed Shearing Auxetics,” IEEE Robotics and Automation Letters, 6, 795-802 (2021). This combination of motors and fluidic sensing yields a soft robotic system with robust actuation and perception capabilities. Disclosed structures are not susceptible to failure by over-pressurization or leakage as is common in fluidically actuated soft robots, allowing devices/systems in which they are incorporated to operate extensive periods of time. As disclosed herein, large sensorimotor data sets can be collected and used to develop a deep neural network to proprioceptively predict the multi-degree-of-freedom actuator's kinematics. Fluidic innervation of the HSAs' complex, sparse geometry represents a first embodiment of a multifunctional construct that enables integrated structural, sensing, and actuation capabilities achieved from one single build material.

According to one aspect of the disclosure, a device can include: a sensorized structure having a plurality of distributed fluidic networks; and a plurality of pressure transducers connected to respective ones of the distributed fluidic networks via air tight connectors, the pressure transducers generating output signals responsive to deformation of the sensorized structure. In some embodiments, the sensorized structure may include a cubic lattice structure, a body-centered cubic (BCC) lattice structure, or an octahedral lattice structure. In some embodiments, the sensorized structure may include a handed shearing auxetic (HSA) structure. In some embodiments, the air tight connectors may include elastomeric tubing. In some embodiments, the pressure transducers can be differential pressure transducers. In some embodiments, the sensorized structure may comprise a single build material, such as photopolymer resin.

According to another aspect of the disclosure, a method can include: forming a sensorized structure with a plurality of distributed fluidic networks; aspirating non-polymerized resin from within the fluidic networks; curing the sensorized structure; and connecting the fluidic networks to pressure transducers via air tight connectors. In some embodiments, forming the sensorized structure may include 3D printing the structure from a single build material, such as photopolymer resin. In some embodiments, 3D printing the structure may involve digital light processing (DLP). In some embodiments, forming the sensorized structure may include forming a lattice structure, such as a cubic, BCC, or octahedral lattice structure. In some embodiments, forming the sensorized structure includes forming HSA structure.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a perspective view of a fluidically innervated sensorized cubic lattice structure, according to embodiments of the present disclosure.

FIGS. 1A and 1B illustrate steps that may be performed to manufacture the structure of FIG. 1, according to some embodiments.

FIG. 1C is an end perspective view of the structure of FIG. 1 showing a sensor map for nine sensors in the lattice.

FIG. 2 is a schematic diagram of a system having a fluidically innervated sensorized structure connected to a plurality of pressure transducers, according to some embodiments.

FIG. 3A is an end perspective view of a fluidically innervated sensorized cubic lattice structure with flexible tubing running from each of nine sensors, according to some embodiments.

FIG. 3B shows the sensorized structure of FIG. 3 in at at-rest configuration.

FIGS. 3C-3F show the sensorized structure of FIG. 3 being bent in four different directions.

FIGS. 3G-3J show the sensorized structure of FIG. 3 subject to four different tactile, pressing interactions on the structure of FIG. 3A.

FIG. 4A is a plot of signals that can be generated in response to the manual bending shown in FIGS. 3C-3F, according to some embodiments.

FIG. 4B is a plot of signals that can be generated in response to the different tactile, pressing interactions shown in FIGS. 3G-3J, according to some embodiments.

FIG. 5A is a front view of a fluidically innervated sensorized body-centered cubic (BCC) lattice structure, according to some embodiments.

FIG. 5B is a perspective view of the structure of FIG. 5A.

FIG. 5C illustrates compression tests being performed of the structure of FIG. 5A.

FIG. 5D is a pair of plots showing measurements obtained from the compression tests illustrated in FIG. 5C.

FIGS. 5E and 5F are plots showing step compression on the structure of FIG. 5A (right-side plots) and corresponding fluidic sensor responses (left-side plots).

FIG. 6A is a front view of a fluidically innervated sensorized octahedral lattice structure, according to some embodiments.

FIG. 6B is a perspective view of the structure of FIG. 6A.

FIG. 6C illustrates compression tests being performed of the structure of FIG. 6A.

FIG. 6D is a pair of plots showing measurements obtained from the compression tests illustrated in FIG. 6C.

FIGS. 6E and 6F are plots showing step compression on the structure of FIG. 6A (right-side plots) and corresponding fluidic sensor responses (left-side plots).

FIG. 7A is a pictorial diagram of a fluidically innervated sensorized handed shearing auxetic (sHSA) structure configured for linear movement, according to some embodiments.

FIG. 7B is a pictorial diagram of another fluidically innervated sHSA structure configured for bending, according to some embodiments.

FIGS. 7C and 7D illustrate extension tests being performed on an fluidically innervated sHSA structure.

FIG. 7E is a pair of plots showing extension force and voltage change measurements that can be obtained during the extension tests of FIGS. 7C and 7D.

FIG. 7F shows a soft robotic actuator comprised of two bending-type sHSA structures of opposite handedness, according to some embodiments, in an at-rest configuration.

FIG. 7G shows the soft robotic actuator of FIG. 7F in a bent configuration.

FIG. 7H is a pair of plots showing servo input and corresponding voltage change measurements that can be obtained as the soft robotic actuator of FIG. 7F undergoes three actuation cycles.

FIG. 8A shows a sensorized soft robot system utilizing four sHSAs of the configuration shown in FIG. 7A, according to some embodiments.

FIG. 8B shows robot system of FIG. 8A in various different postures.

FIG. 8C is a series of plots showing measurements of voltage changes that can be obtained from the sensorized soft robot system of FIG. 8A as it moves between different postures over time.

FIGS. 9A and 9B illustrate a network architecture that can be used to associate sensor feedback with deformation for proprioception, according to some embodiments.

FIG. 9C illustrates how postures of a sHSA-based soft robot that can be predicted using techniques disclosed herein, along with corresponding ground truth postures.

The drawings are not necessarily to scale, or inclusive of all elements of a system, emphasis instead generally being placed upon illustrating the concepts, structures, and techniques sought to be protected herein.

### DETAILED DESCRIPTION

### 3D Printing Sensorized Architected Materials

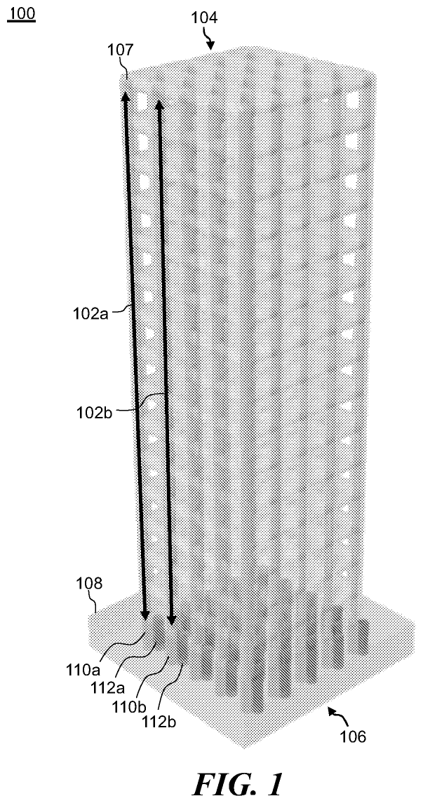

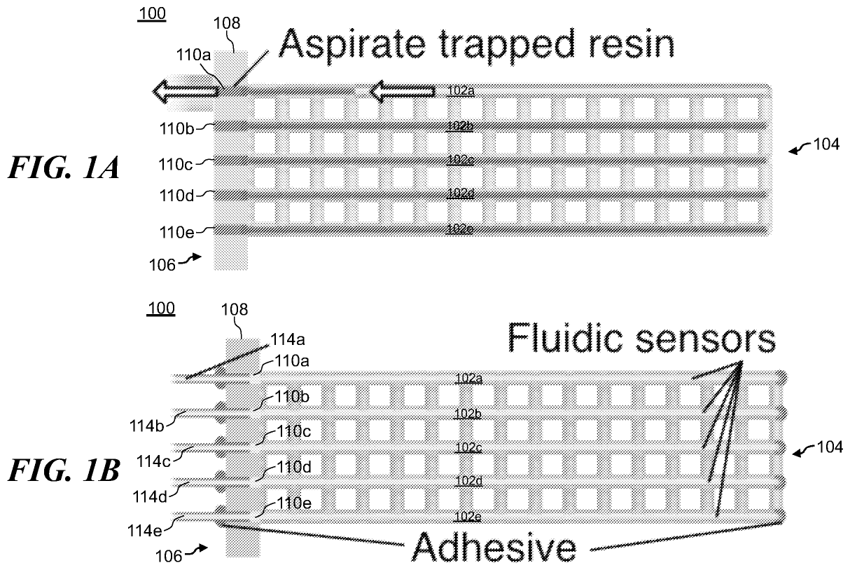

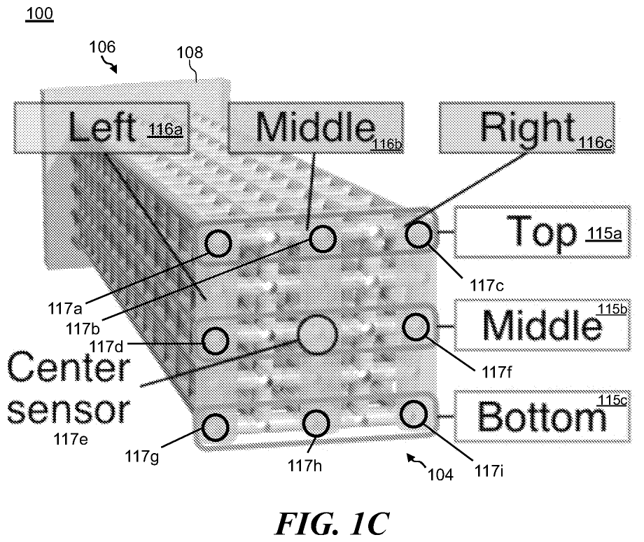

FIG. 1 shows a fluidically innervated sensorized cubic lattice structure 100, according to embodiments of the present disclosure. The concepts and techniques disclosed herein may be used to design and manufacture sensorized structures having various different lattice architectures including but not limited to cubic, BCC, and octahedral lattice architectures.

The illustrative structure 100 may be 3D printed via digital light processing (DLP) from a single build material, such as a photopolymer resin. The build material may be selected such that, once cured, the structure 100 is flexible to manual interactions, such as bending and pressing. The structure 100 includes a plurality of channels 102a, 102b, etc. (102 generally) that extend from a top 104 of the structure to a bottom 106 of the structure. In the example of FIG. 1, structure 100 includes twenty-five channels 102, although only two channels 102a, 102b are labeled. Each of the plurality of channels 102a, 102b, etc. is be sealed off near the top 104 of the structure (e.g., using an adhesive) and connected to a respective one of a plurality of through ports 110a, 110b, etc. (110 generally) near the bottom 106 of the structure. For example, one end of first channel 102a terminates near position 107 in the figure, while the other end connects to a first through port 110a. As shown, a base 108 can be formed at the bottom 106 of the structure 100 and the ports 110 can extend through the thickness of the base 108 to provide through holes from the bottom 106 of the structure up to each respective channel 102. In some embodiments, the base 108 may be wider than the rest of the structure 100 to facilitate mounting and/or provide additional strength around the ports 110, 112.

One of more of the channels 102 and the corresponding one of the through ports 110 may be utilized as fluidic sensors (or “sensor networks”) to sense deformation of the structure 100 that may result, for example, from manual bending or pressing. In more detail, a pressure transducer (not shown) can be connected to a given through port 110 via flexible tubing (or other type of air tight fluidic connection means) and sealed with adhesives to form a closed volume. Perceivable pressure changes of the closed volumes can be used as the basis of fluidic sensors. In some cases, the closed volume may be filled only with air, although other gaseous and liquid fluids may be used.

In some embodiments, a pressure transducer may be provided as differential pressure transducer having two ports. One a first port of the transducer may be connected to a corresponding through port 110 of the structure 100 via a first line (i.e., flexible tubing) and a second port of the transducer may be connected to a “dummy” line (i.e., other flexible tubing). In some embodiments, and as shown in FIG. 1, the structure's base 108 can further include a plurality of dummy ports 112a, 112b, etc. (112 generally) that are sealed off to provide connection points for the dummy lines. In some cases, the dummy ports 112 may be formed adjacent to corresponding ones of the through ports 110. In the example of FIG. 1, structure 100 includes twenty-five through ports 110 and twenty-five corresponding dummy ports 112. In other embodiments, the dummy lines may terminate outside the structure 100.

Turning to FIG. 1A, non-polymerized resin trapped within the fluidic sensors (e.g., within channels 102a-102e and/or respective through ports 110a-110e) during the printing process can be aspirated by vacuum, and the channels 102 can be flushed with solvent and left empty.

Turning to FIG. 1B, after the structure 100 is completely cured, individual fluidic sensors can be connected to respective pressure transducers (not shown) via elastomeric tubing 114a-114e and sealed with adhesives. In some embodiments, channels 102 are 3D printed to have openings near the top 104 of the structure and then sealed off after the structure is cleaned and cured. Thus, adhesive may be used to seal both ends of a given fluidic sensor network, as illustrated in FIG. 1B.

While DLP affords the patterning resolution required to create complex structures (e.g., the various different lattice structures described herein), it is appreciated herein that overall green-body strength and printing resin's viscosity and pot life may limit the overall dimensions of fluidic features that can be patterned (e.g., the length and diameter of channels 102). Thus, in some cases, the printing resin may be selected according to the overall dimensions of fluidic features desired for a given application. Non-limiting examples of printing resins that may be selected include elastomeric polyurethane (EPU 40), flexible polyurethane (FPU 50), and a transparent resin Loctite 3D IND405 (LOCTITE) photopolymer resins (all from Carbon, Inc.).

FIG. 1C shows a sensor map for nine sensors that can be utilized within the cubic lattice structure 100. Looking from the top 104, the twenty-five channels can be viewed as a 5×5 matrix having a top row 115a, a middle row 115b, a bottom row 115c, a left column 116a, a middle column 116b, and a right column 116c. The intersection of rows 115a-115c and columns 116a-116c may correspond to the nine fluidic sensors, denoted as: Top-Left 117a, Top-Mid 117b, Top-Right 117c, Mid-Left 117d, Center 117e, Mid-Right 117f, Btm-Left 117g, Btm-Mid 117h, and Btm-Right 117i. The lattice has nine straight fluidic sensors running along its length. The “Top” and “Bottom” (Btm) sensors lie on the top and bottom row of struts in the beam, respectively. The “Middle” (Mid) sensors lie in the center row of struts, at the approximate neutral plane of the beam during downward and upward bending. “Left”, “Middle”, and “Right” sensors fall in the leftmost, middle, and rightmost columns of struts. The number and location of sensors 117a-117i within the lattice structure 100 is merely one example and other numbers and locations of sensors can be used. For example, illustrative lattice structure 100 may allow for up to twenty-five separate fluidic sensors.

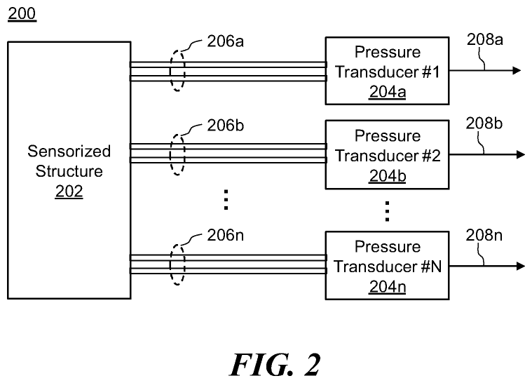

FIG. 2 schematically illustrates a system 200 having a fluidically innervated sensorized structure 202 connected to N differential pressure transducers 204a, 204b, . . . , 204n (204 generally) via N corresponding pairs of flexible tubing lines 206a, 206b, . . . , 206n (one of each pair being a dummy line) to form N fluidic sensors. In some cases, structure 202 may have lattice architecture such as any of the lattice architectures shown and described herein. In some cases, structure 202 can correspond to an HSA structure, such as any of the HSA structures shown and described herein.

According to Boyle's law, deformation of the fluidically innervated materials results in changes of the internal pressure of the sensor networks, P, inversely proportional to volume changes (i.e., decreases via compression, increases via extension). For each of the N sensors, P can be measured using the in-line differential pressure transducers 204, which report P-dependent voltages, V, as output. In more detail, each of the pressure transducers 204a, 204b, . . . , 204n can generate a respective output signal 208a, 208b, . . . , 208n (208 generally) having a voltage responsive to the internal pressure of the respective sensor network. Output signals 208 can be processed to determine information about the material deformation of sensorized structure 202, as discussed next.

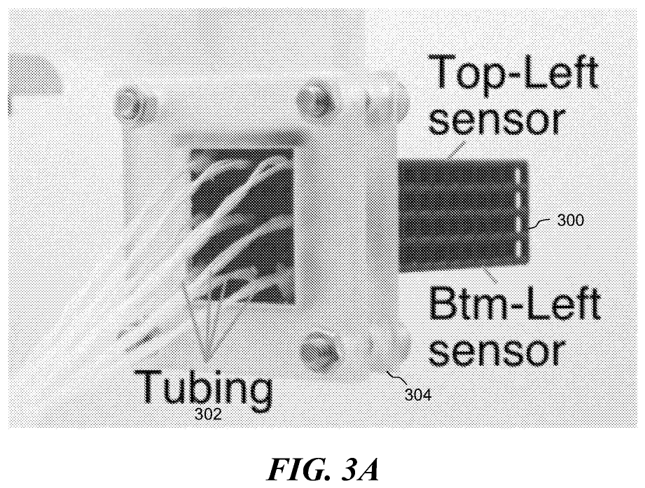

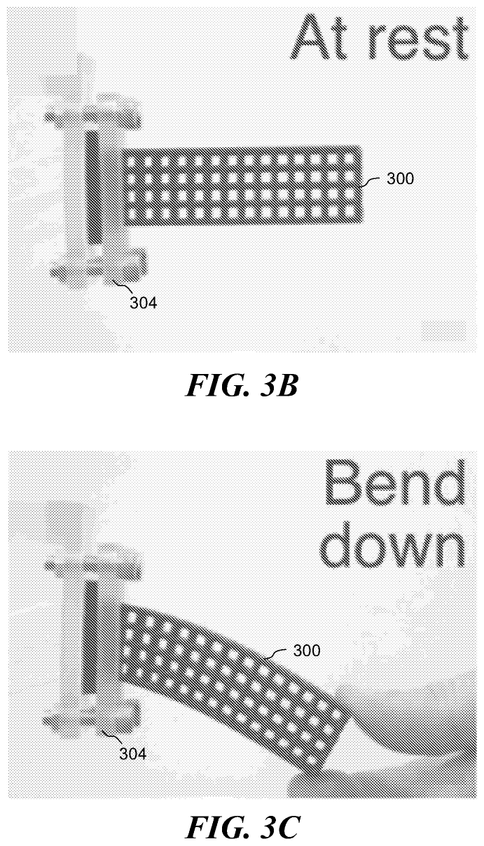

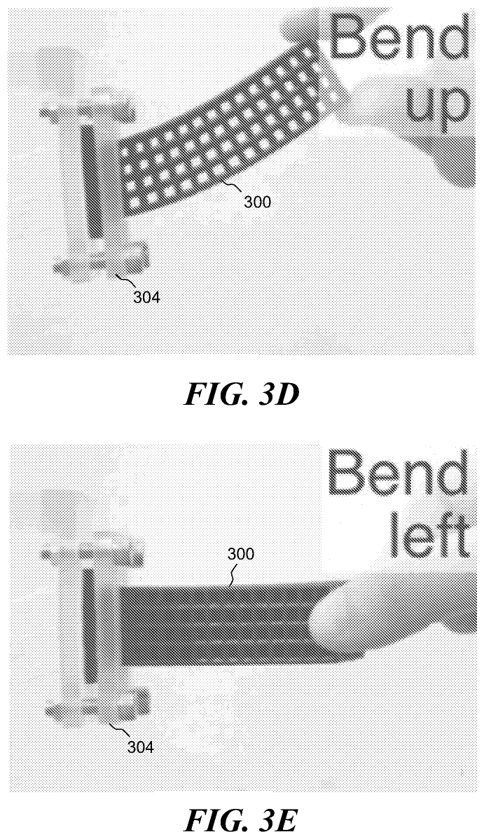

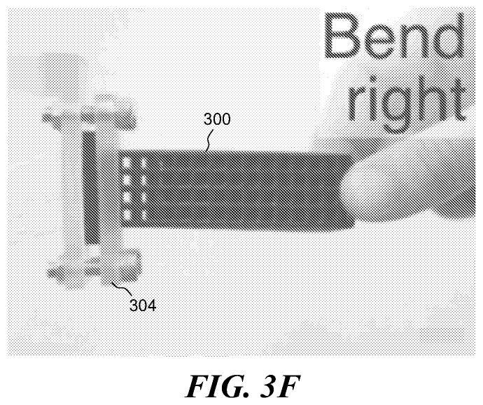

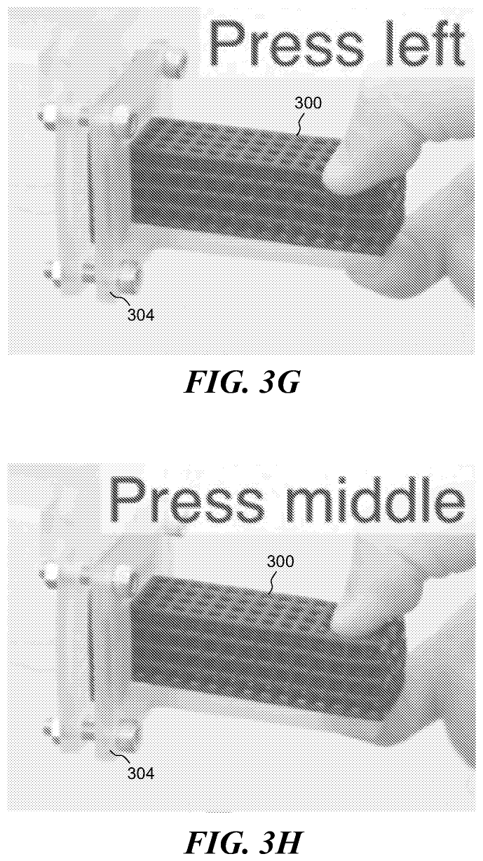

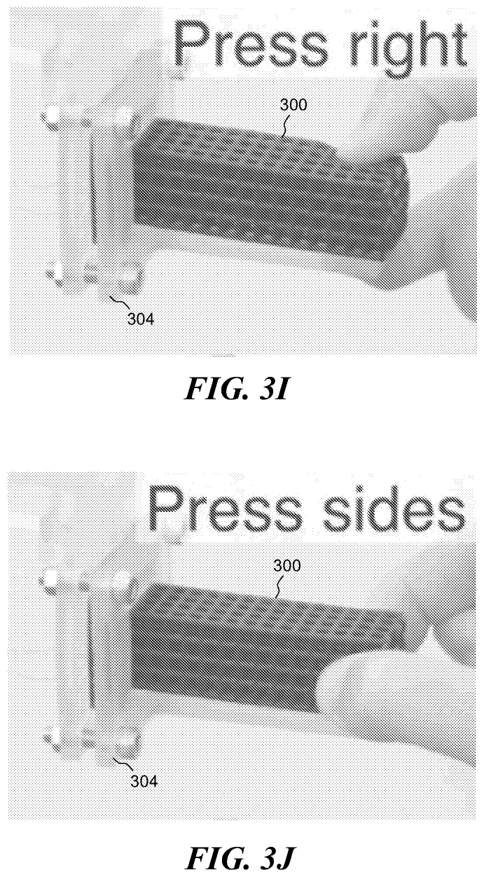

FIG. 3A is an end perspective view of a fluidically innervated sensorized cubic lattice structure 300 with flexible tubing lines 302 running from each of nine sensors. Flexible structure 300, which may be the same as or similar to structure 100 of FIG. 1, can be secured within a rigid mount 304 during testing and/or operation. As shown, two lines 302 may be provided for each of the nine sensors, with one of a pair of lines corresponding to a dummy line.

FIG. 3B shows a side view of the mounted, sensorized structure 300 at rest. FIGS. 3C-3F show the structure 300 being bent in four different directions, namely: down (FIG. 3C), up (FIG. 3D), left (FIG. 3E), and right (FIG. 3F). FIGS. 3G-3J shows a side perspective view of the mounted, sensorized structure 300 being subject to four different tactile, pressing interactions, namely: press left (FIG. 3G), press middle (FIG. 3H), press right (FIG. 3I), and press sides (FIG. 3J).

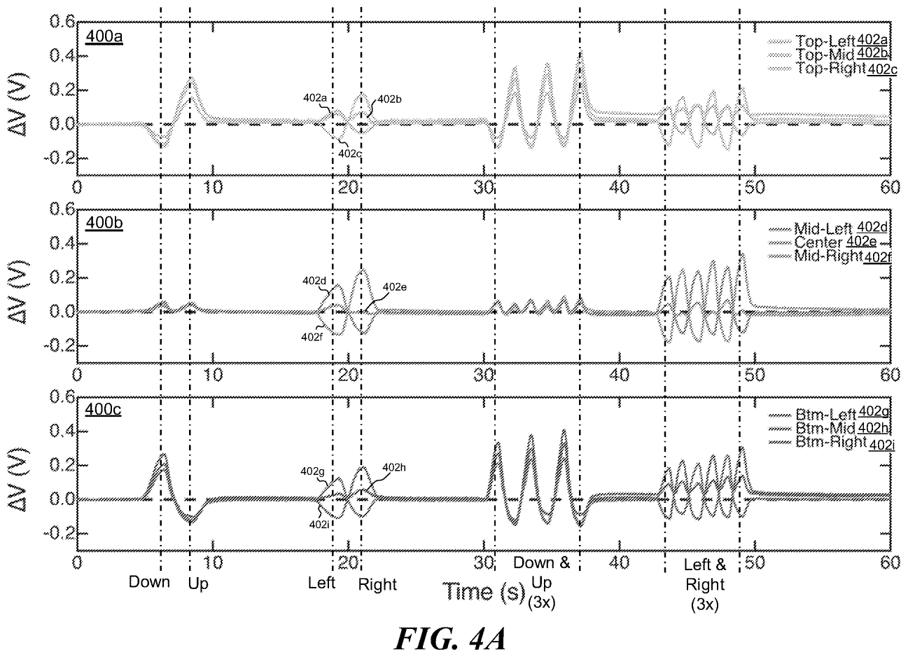

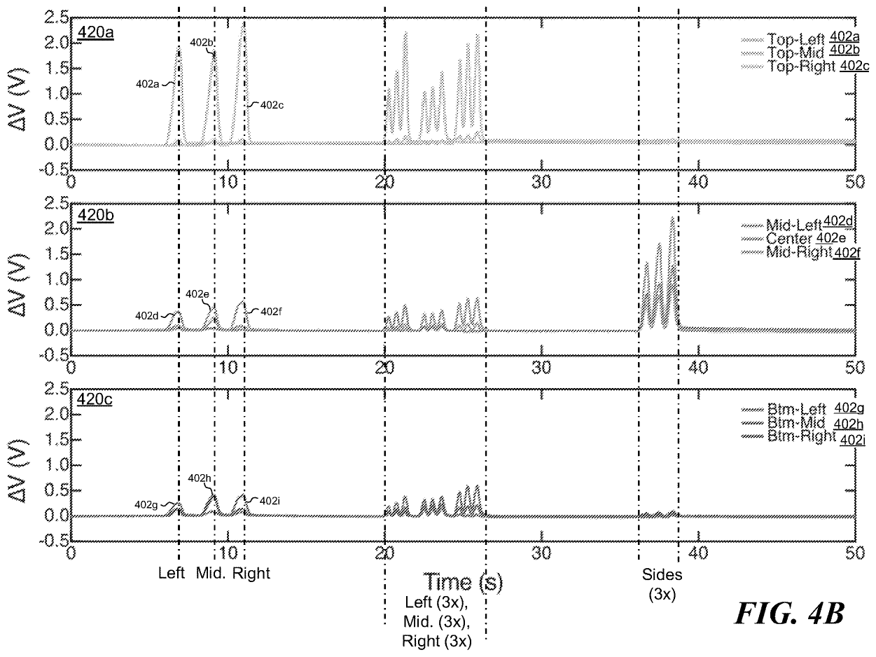

FIG. 4A is a series of plots of signals that can be generated in response to the manual bending shown in FIGS. 3C-3F, according to some embodiments. Here, the sensorized cubic lattice structure 300 may be configured to have the arrangement of nine fluidic sensors shown in FIG. 1C, namely: Top-Left 117a, Top-Mid 117b, Top-Right 117c, Mid-Left 117d, Center 117e, Mid-Right 117f, Btm-Left 117g, Btm-Mid 117h, and Btm-Right 117i. Each of these may be connected to a separate transducer, resulting in nine output signals having voltages responsive to the internal pressure of the respective fluidic sensor.

FIG. 4A shows voltage change, ΔV, of corresponding nine output signals 402a-402i over time. For clarify, the figure is organized into three plots 400a, 400b, and 402c, each showing three (3) of the nine output signals. In particular, plot 400a shows ΔV over time for output signals 402a, 402b, and 402c produced by the Top-Left, Top-Mid, and Top-Right sensors, respectively; plot 400b shows ΔV over time for output signals 402d, 402e, and 402f produced by the Mid-Left, Center, and Mid-Right sensors, respectively; and plot 400c shows ΔV over time for output signals 402g, 402h, and 402i produced by the Btm-Left, Btm-Mid, and Btm-Right sensors, respectively.

In this example, the sensorized structure undergoes the following sequences of bending over a 60 second period of time (T):
around T=6 seconds, bend down;
around T=9 seconds, bend up;
around T=19 seconds, bend left;
around T=21 seconds, bend right;
between about T=31 seconds and T=36 seconds, bend down-then-up three times; and
between about T=44 seconds and T=49 seconds, bend left-then-right three times.

Turning to FIG. 4B, plots 420a, 420b, and 420c show voltage change, ΔV, of the nine sensor output signals 402a-402i over time in response to the tactile, pressing interactions shown in FIGS. 3G-3J.

In this example, the sensorized structure undergoes the following sequences of presses over a 50 second period of time (T):
around T=6 seconds, press left;
around T=9 seconds, press middle;
around T=11 seconds, press right;
between about T=20 seconds and T=26 seconds, press left three times, middle three times, and then right three times; and
between about T=36 seconds and T=39 seconds, press sides three times.

FIGS. 4A and 4B demonstrate the general operating principles of fluidically innervated sensorized structures disclosed herein. In the example of FIGS. 4A and 4B, the sensorized structure may correspond to a cubic lattice printed from an elastomeric resin (e.g., EPU 40), with nine fluidic sensors arranged as in FIG. 1C. Thus, left and right sensors lie on opposite sides of the neutral plane when the beam undergoes left- and rightward bends.

FIG. 4A shows that, as the cubic lattice undergoes manual bending (FIGS. 3C-3F), a decrease in P is observed for the sensors lying above the neutral plane (ΔV<0), while sensors below it report an increase in P(ΔV>0). Notably, middle sensors lying in the neutral plane only produce a small voltage increase, likely due to compression by the solid struts parallel to the direction of bending.

FIG. 4B explores tactile sensor response by pressing on individual columns of sensors (FIGS. 3G-3J). In all instances, P increases during compression (ΔV>0), which are consistent with the results from manual bending. It has also been demonstrated that the sensors have a depth-dependent response, with sensors closer to the contact point providing greater ΔV than those further from it.

Importantly, for both manual bending and pressing, the sensorized structures provides a highly responsive feedback from all sensors during lattice deformation. Any instances where ΔV does not return to ΔV=0 after deformation result from either the lack of precise motion in manual deformations and/or the intrinsic creep and stress relaxation of the proprietary viscoelastic resins. See, e.g., R. L. Truby, L. Chin, D. Rus, “A Recipe for Electrically-Driven Soft Robots via 3D Printed Handed Shearing Auxetics,” IEEE Robotics and Automation Letters, 6, 795-802 (2021). The inventors have shown that embodiments of the sensorized structures disclosed herein provide stable sensing over a 12-hour thermal drift study.

### Mechanical Characterization of Sensorized Lattices

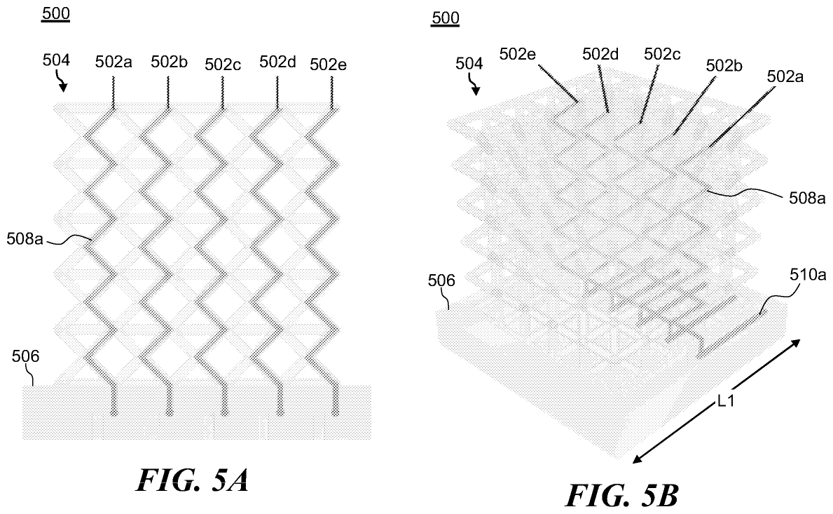

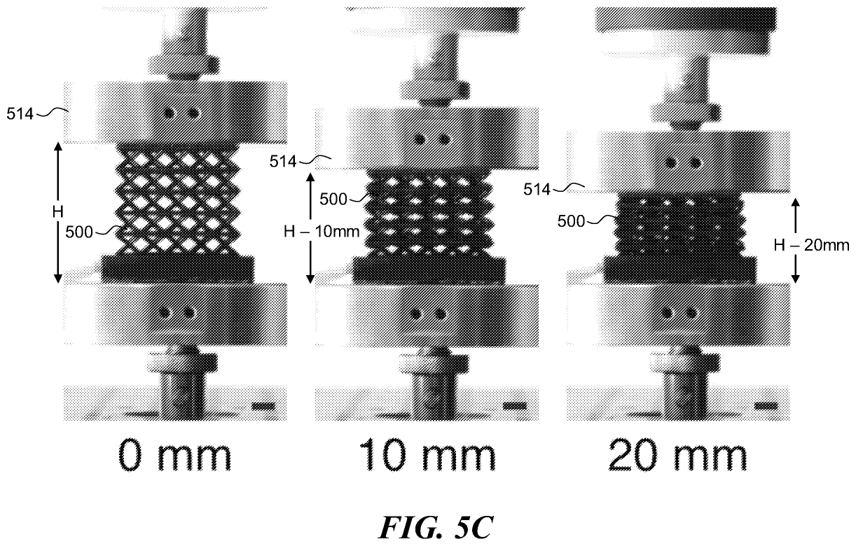

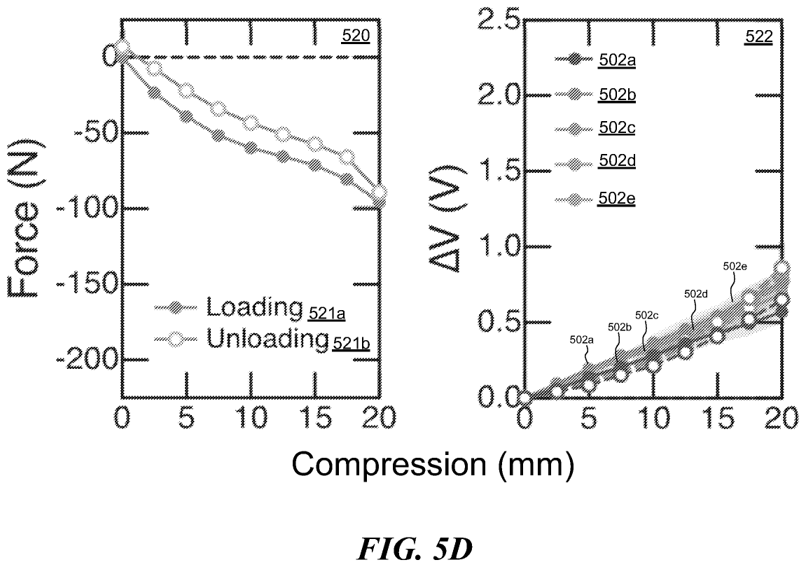

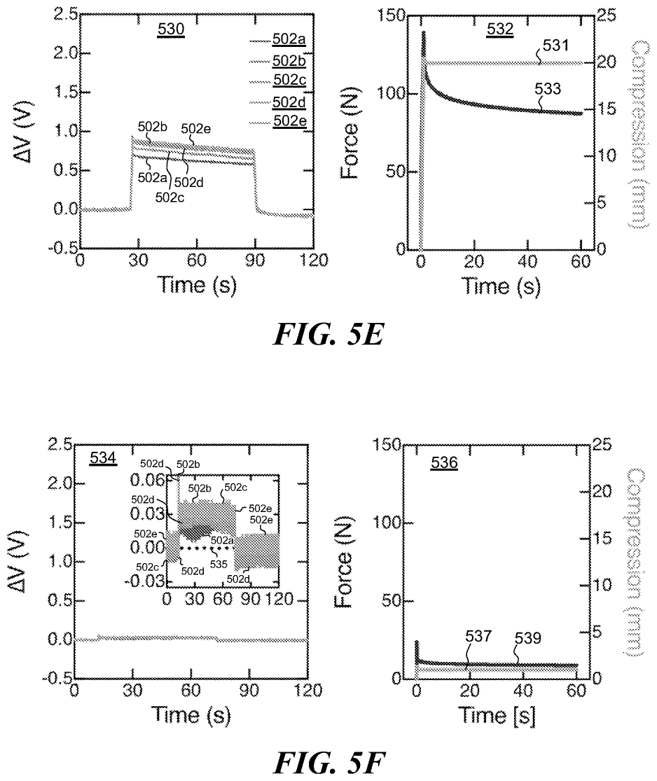

Turning to FIGS. 5A and 5B, a fluidically innervated sensorized body-centered cubic (BCC) lattice structure 500 includes five (5) sensors 502a-502e (502 generally), each comprising a channel that zigzags from a top 504 of the structure 500 down to a base 506 of the structure and a corresponding through port for connection with flexible tubing (and, in turn, pressure transducers). For example, first sensor 502a includes first channel 508a that zigzags from the top 504 of the structure to the base 506 and a corresponding through port 510a. In the example of FIG. 5B, the top-to-bottom channels of the five (5) sensors 502 are centered within the structure 500 along the indicated length L1. Other numbers and placements of sensors may be used.

FIG. 5C illustrates compression tests being performed of the BCC lattice structure 500 having a height H mm (uncompressed). In particular, the structure 500 is shown mechanically compressed to distances of 0 mm, 10 mm, and 20 mm. A compression testing apparatus 514 may be used to step the compression distance at fixed intervals between 0 mm and 20 mm (e.g., 1 mm or 20 mm intervals) and to obtain measurements of force exerted on the compression testing apparatus 514 by the compressed structure 500.

FIG. 5D shows measurements obtained from the step compression tests illustrated in FIG. 5C. A first plot 520 shows force (as measured by the compression testing apparatus 514 of FIG. 5C) versus compression distance, and a second plot 522 shows voltage change, ΔV, versus compression response from all five (5) sensors 502a-502e. In FIG. 5D, data points and error bands represent mean and standard deviation (n=3), and loading (line 521a) and unloading data (line 521b) are provided as filled and unfilled symbols, respectively. During loading, compression is increased, so time moves from left to right along plot line 521a. During unloading, compression is decreased, so time moves from right to left along plot line 521b. The difference in path between loading and unloading corresponds to hysteresis of the system and is a material property of the underlying material. This behavior can be observed, to some degree, in the data obtained from fluidic sensors disclosed herein.

FIGS. 5E and 5F show fluidic sensor response of the structure of FIG. 5A during step compressions, with FIG. 5E showing 20 mm step compression and FIG. 5F showing 1 mm step compression.

Referring to FIG. 5E, a first plot 530 shows sensor voltage change, ΔV, over time for the five (5) fluidic sensors 502a-502e during 20 mm step compressions. A second plot 532 shows force and compression data over time as measured via the compression testing apparatus during 60-sec step compressions of 20 mm. Plot line 531 corresponds to the applied step compression (mm) while line 533 shows the force (N) measured by the mechanical tester.

Referring to FIG. 5F, a first plot 534 shows sensor voltage change, ΔV, over time for the five (5) fluidic sensors 502a-502e (using the same legend as in FIG. 5E) during 1 mm step compressions. The inset in plot 534 is scaled to observe the small but measurable sensor changes in response to 1 mm of compression. ΔV=0 is indicated in the inset by dotted line 535. A second plot 536 shows force and compression data over time as measured via the compression testing apparatus during 60-sec step compressions of 1 mm, with line 537 corresponding to the applied step compression (mm) and line 539 showing the force (N) measured by the mechanical tester.

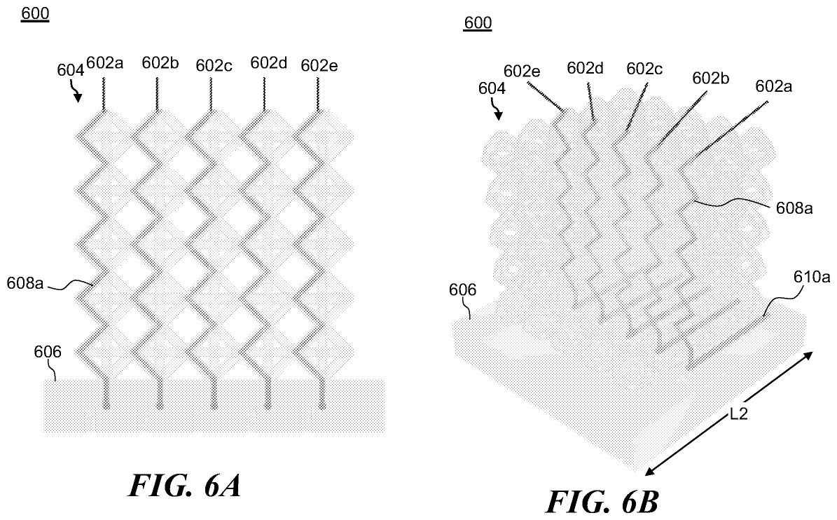

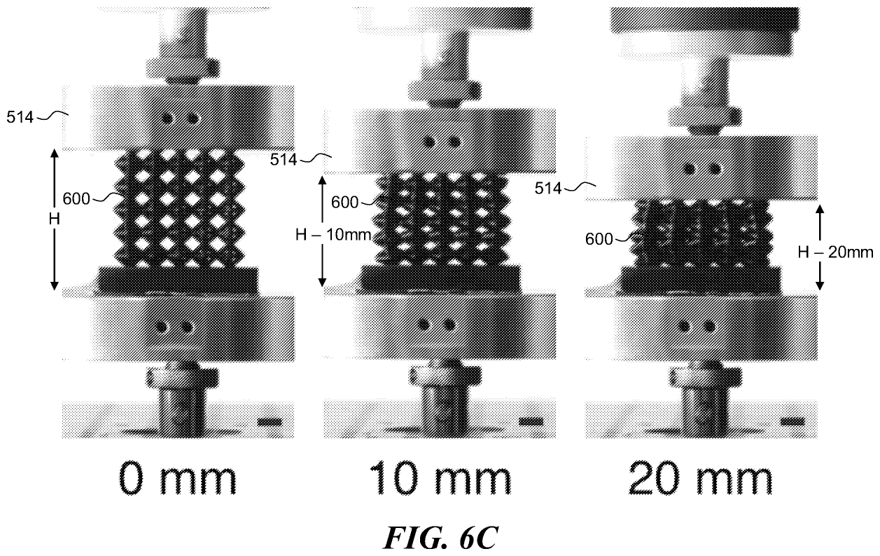

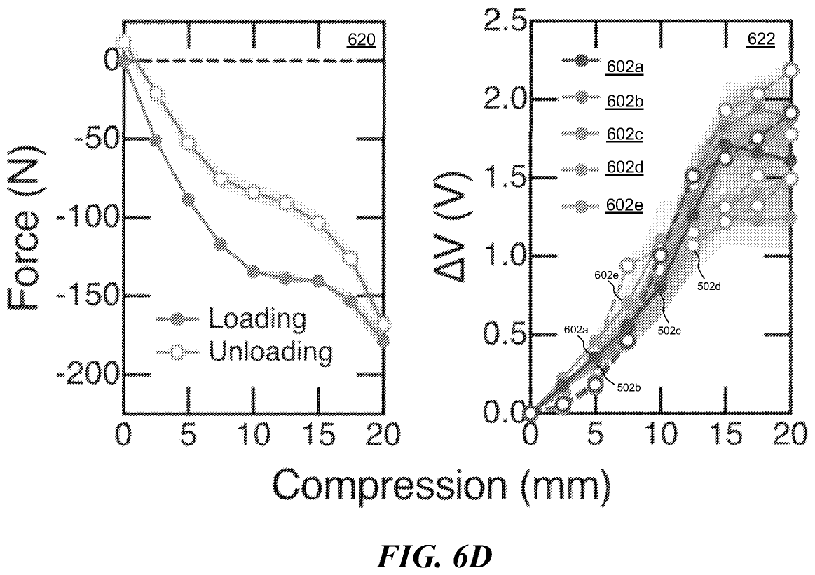

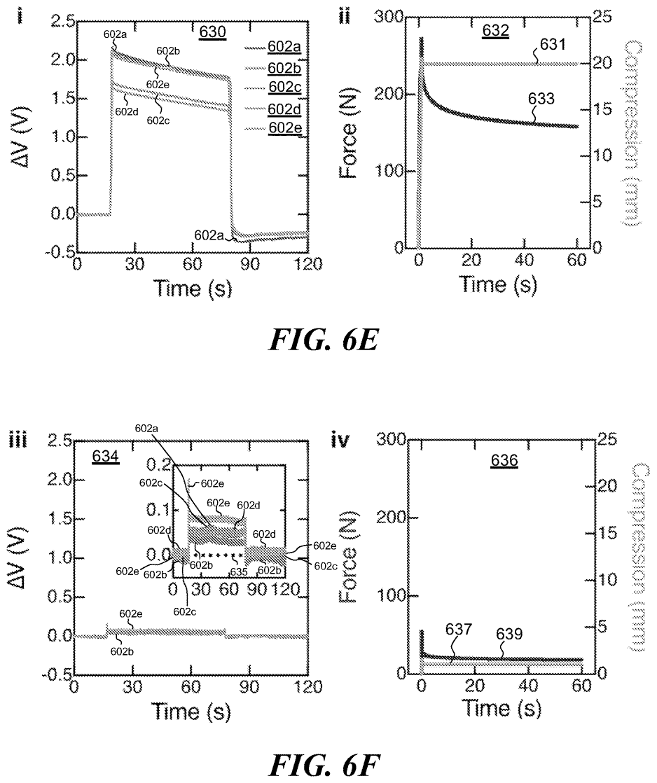

Turning to FIGS. 6A and 6B, a fluidically innervated sensorized body-centered octahedral lattice structure 600 includes five (5) sensors 602a-602e (602 generally), each comprising a channel that zigzags from a top 604 of the structure 600 down to a base 606 of the structure and a corresponding through port for connection with flexible tubing (and, in turn, pressure transducers). For example, first sensor 602a includes first channel 608a that zigzags from the top 604 of the structure to the base 606 and a corresponding through port 610a. In the example of FIG. 6B, the top-to-bottom channels of the five (5) sensors 602 are centered within the structure 600 along the indicated length L2. Other numbers and placements of sensors may be used.

FIG. 6C illustrates compression tests being performed of the octahedral lattice structure 600 having a height H mm (uncompressed). In particular, the structure 600 is shown mechanically compressed to distances of 0 mm, 10 mm, and 20 mm. Compression testing apparatus 514 may be used to step the compression distance at fixed intervals between 0 mm and 20 mm (e.g., 1 mm or 2 mm intervals) and to obtain measurements of force exerted on the compression testing apparatus 514 by the compressed structure 600.

FIG. 6D shows measurements obtained from the step compression tests illustrated in FIG. 6C. A first plot 620 shows force (as measured by the compression testing apparatus 514 of FIG. 6C) versus compression distance, and a second plot 622 shows voltage change, ΔV, versus compression response from all five (5) sensors 602a-602e. In FIG. 6D, data points and error bands represent mean and standard deviation (n=3), and loading and unloading data are provided as filled and unfilled symbols, respectively.

FIGS. 6E and 6F show fluidic sensor response of the structure of FIG. 6A during step compressions, with FIG. 6E showing 20 mm step compression and FIG. 6F showing 1 mm step compression.

Referring to FIG. 6E, a first plot 630 shows sensor voltage change, ΔV, over time for the five (5) fluidic sensors 602a-602e during 20 mm step compressions. A second plot 632 shows force and compression data over time as measured via the compression testing apparatus during 60-sec step compressions of 20 mm. Plot line 631 corresponds to the applied step compression (mm) while line 633 shows the force (N) measured by the mechanical tester.

Referring to FIG. 6F, a first plot 634 shows sensor voltage change, ΔV, over time for the five (5) fluidic sensors 602a-602e (using the same legend as in FIG. 6E) during 1 mm step compressions. The inset in plot 634 is scaled to observe the small but measurable sensor changes in response to 1 mm of compression. ΔV=0 is indicated in the insets by the dotted line 635. A second plot 636 shows force and compression data over time as measured via the compression testing apparatus during 60-sec step compressions of 1 mm, with line 637 corresponding to the applied step compression (mm) and line 639 showing the force (N) measured by the mechanical tester.

The data shown in FIGS. 5D-5F and FIGS. 6D-6F show a quantitative study of fluidic sensing with elastomeric, fluidically innervated body-centered cubic (BCC) and octahedral lattices undergoing compression. BCC (M=−13) and octahedral lattices (M=0) are compared for their similar architecture yet different bending- and stretching-dominated mechanical behaviors, respectively, according to Maxwell's stability criterion, M.

As can be seen by the plots of FIGS. 5D and 6D, the octahedral lattice is stiffer than the BCC lattice. This stiffness is reflected in the higher ΔV measured in the octahedral lattice's sensors, corresponding to higher forces required for compression. In these experiments, it can be observed that the five sensors in each lattice behave similarly for compressive forces below approximately 100 N. Above 100 N, sensors in the octahedral lattice show greater variability with increased compression on account of the lattices' extreme, heterogeneous deformation in this regime.

To understand the dynamic response of the fluidic sensors under step compressions, sensor responses were recorded for sensorized BCC and octahedral lattices compressed to fixed distances. FIGS. 5E, 5F, 6E, and 6F provide the dynamic sensor responses of the BCC and octahedral lattices undergoing 60-sec step compressions of 20 mm and 1 mm. The corresponding mechanical responses measured are provided in FIGS. 5E, 5F, 6E, and 6F. The decrease in compressive force over the 60-sec hold indicates the stress relaxation in the lattices. For each lattice, it is observed that overall magnitude in sensor response ΔV decreases with decreasing compression distance. This is in agreement with FIGS. 5D and 6D. Even the 1 mm compressions produce a measurable ΔV as shown in plots 536 (FIG. 5F) and 636 (FIG. 6F). It can also be seen that the magnitude in sensor response for each compression distance is greater for the stiffer octahedral lattice than the BCC. Importantly though, it is observed a time-varying decay in ΔV over the 60-sec compression that corresponds to the stress relaxation response in plots 532 (FIG. 5E), 536 (FIG. 5F), 632 (FIG. 6E), and 636 (FIG. 6F). The inventors have shown that the octahedral lattice may require several seconds to return to its initial dimensions when the compressive force is removed, revealing the extent of stress relaxation in these viscoelastic resins.

Data from cyclic compression experiments conducted by the inventors further reveal that the viscoelasticity of the crosslinked resins is responsible for any time-varying behavior in the sensors. Even after 10,000 cycles of compression, the inventors observed largely non-hysteretic sensor responses given the fluidic sensing approach. Overall, the fluidic sensors' performance during mechanical characterization suggests that the disclosed sensorization techniques are practical for architected structures and provide reliable alternatives to soft matter-based conductors.

In some embodiments, a sensorized lattice structure may have design parameters selected from Table 1.

TABLE 1

| | | Fluidic | | Volume per |
|---|---|---|---|---|
| | | Sensor | Strut | Fluidic |
| Lattice | # Fluidic | Diameter | Diameter | Sensor |
| (Unit Cell Size) | Sensors | (mm) | (mm) | (mm³) |
| Cubic | 9 | 1.25 | 2 | 93 |
| (5 × 5 × 5 mm³) | | | | |
| BCC | 5 | 1 | 2 | 120 |
| (10 × 10 × 10 | | | | |
| mm³) | | | | |
| Octahedral | 5 | 1 | 2 | 117 |
| (10 × 10 × 10 | | | | |
| mm³) | | | | |

Sensorized Handed Shearing Auxetics (sHSAs)

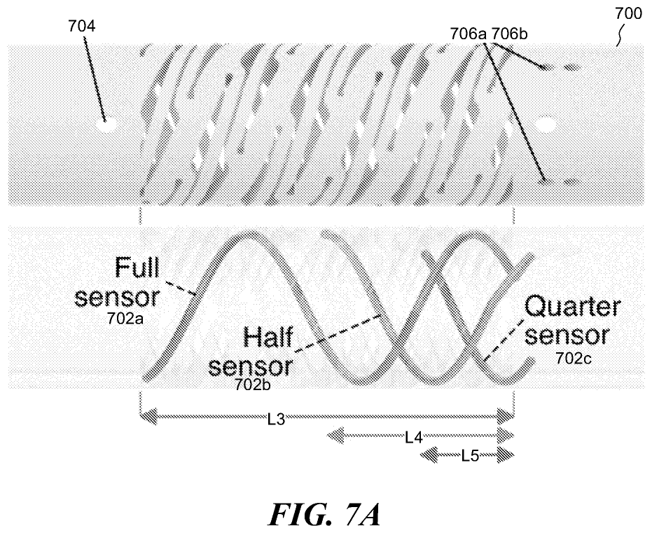

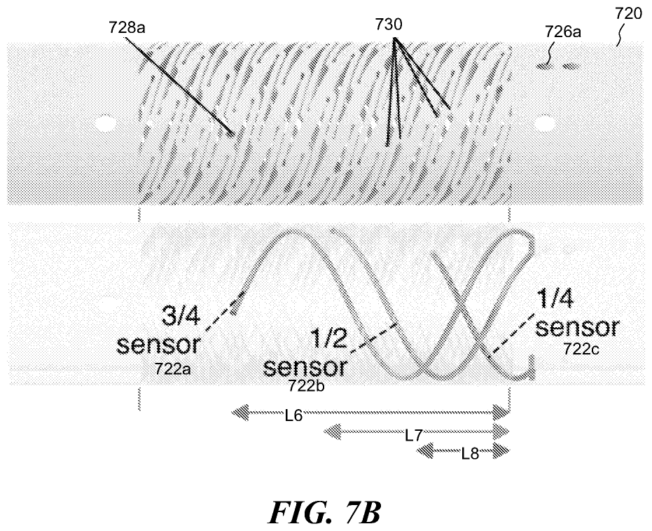

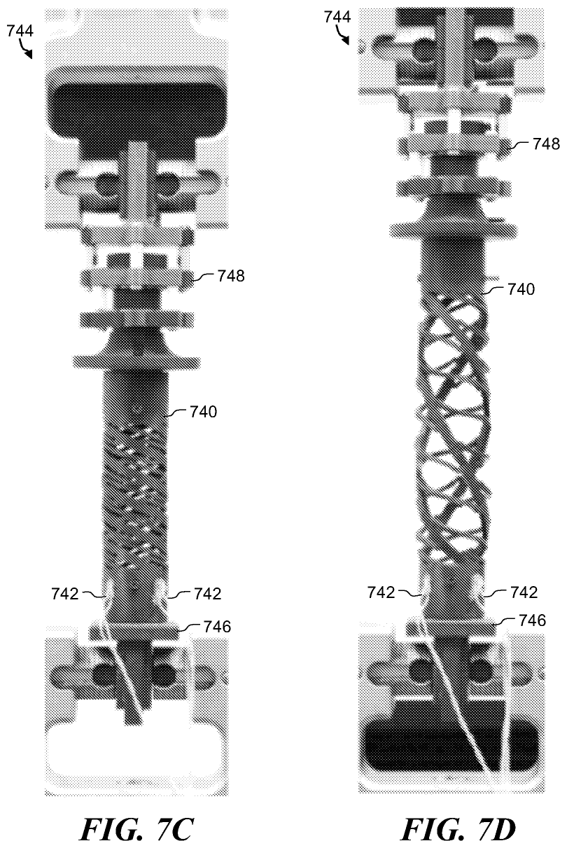

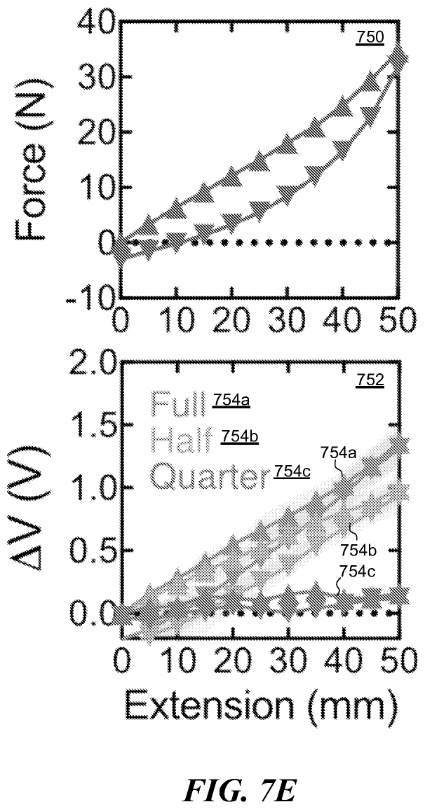

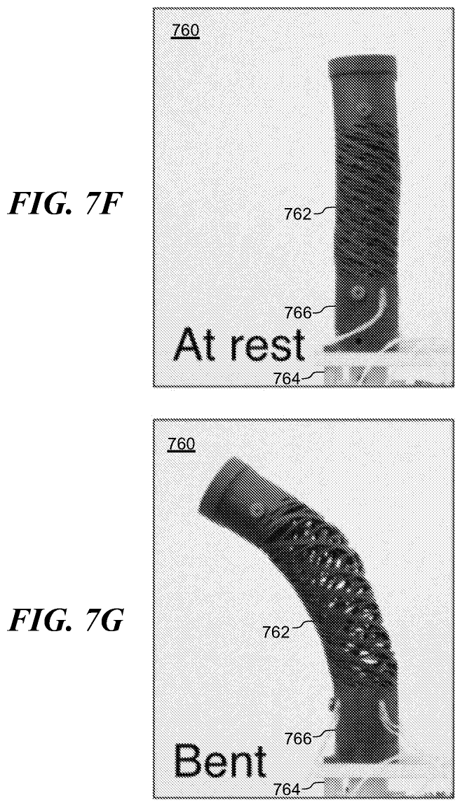

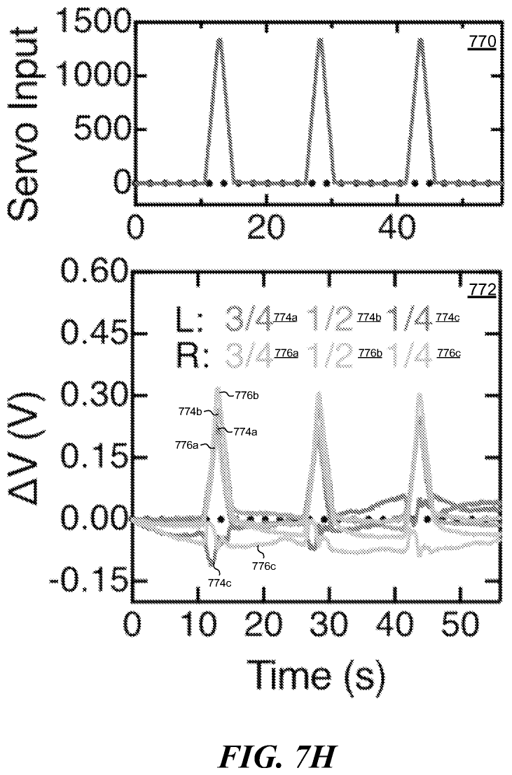

Turning to FIG. 7A, the concepts and techniques disclosed herein can be used to sensorize HSAs, a new class of architected materials developed for the design of motorized soft robots. See, e.g., J. I. Lipton, R. MacCurdy, Z. Manchester, L. Chin, D. Cellucci, D. Rus, “Handedness in shearing auxetics creates rigid and compliant structures,” Science, 360, 632-635 (2018); L. Chin, J. Lipton, R. MacCurdy, J. Romanishin, C. Sharma, D. Rus, in 2018 IEEE-RAS International Conference on Soft Robotics (RoboSoft) (2018); and R. L. Truby, L. Chin, D. Rus, “A Recipe for Electrically-Driven Soft Robots via 3D Printed Handed Shearing Auxetics,” IEEE Robotics and Automation Letters, 6, 795-802 (2021).

Through a repeated joint linkage design, the HSA form tightly couples twisting with linear extension, enabling a single motor to drive a pair of HSAs as a compliant, soft robotic actuator. As with other architected materials, HSAs are difficult to sensorize due to their complex forms, and sensors must accommodate HSAs' extreme deformation. See, e.g., L. Chin, M. C. Yuen, J. Lipton, L. H. Trueba, R. Kramer-Bottiglio, D. Rus, in 2019 International Conference on Robotics and Automation (ICRA) (IEEE, Montreal, QC, Canada, 2019; https://ieeexplore.ieee.org/document/8794098/), pp. 2765-2771. Sensorizing via fluidic innervation bypasses this issue by allowing embedding of sensors within the HSA architecture.

FIG. 7A shows a first example of a fluidically innervated sensorized handed shearing auxetic (sHSA) structure 700 based on a straight, unconstrained variety, according to some embodiments. The structure 700 can be 3D printed from a flexible polyurethane resin (e.g., FPU 50) to have three embedded fluidic sensors 702a, 702b, 702c (702 generally). The sensors 702 include a “Full” sensor 702a spanning a length L3 approximately equal to the sHSA length, a “Half” sensor 702b spanning a length L4 approximately equal to 0.5× the sHSA length, and a “Quarter” sensor 702c spanning a length L5 approximately equal to 0.25× the sHSA length. These asymmetric sensor designs can be selected to sense different areas and modes of sHSA deformation. Sensor inlets may be formed into the sHSA structure 700 allowing fluidic connection to the sensors 702. In FIG. 7A, only two sensor inlets 706a, 706b are visible. To aid in comprehension, the sensors 702 are shown in FIG. 7A below structure 700. It should be understood that sensors 702 are actually printed to weave through the sHSA structure 700 and to terminate at the indicated lengths.

Of note, in order to use HSAs as an actuator, it is necessary to have two HSAs of opposite handedness working together as a pair. Since one twists clockwise and the other twists counterclockwise, they oppose the rotation of the other and maintain their overall extension. In order for this counterrotation to happen, one side of the HSA ends must remain fixed to provide a pivot for the other side to counterrotate against. Thus, as shown in FIG. 7A, mounting holes (e.g., hole 704) may be provided to allow either the ends to be affixed to a stationary “cap” or the ends to be affixed to a rotating shaft.

FIG. 7B shows another example of a fluidically innervated sHSA structure 720 based on a bending, constrained variety, according to some embodiments. Adding constraint features in the HSA turns otherwise linear extension into out-of-plane bending, as discussed in L. Chin, J. Lipton, R. MacCurdy, J. Romanishin, C. Sharma, D. Rus, in 2018 IEEE-RAS International Conference on Soft Robotics (RoboSoft) (2018). The bending sHSA structure 720 also has three sensors 722a-722c (722 generally) printed to weave through the sHSA structure 720. In this example, the sensors 722 include a “¾” sensor 722a spanning a length L6 approximately equal to 0.75× the sHSA length, a “½” sensor 722b spanning a length L7 approximately equal to 0.5× the sHSA length, and a “¼” sensor 722c spanning a length L8 approximately equal to 0.25× the sHSA length. For reference, the end of the “¾” sensor 722a is marked as 728a in the figure. These asymmetric sensor designs can be selected to sense different areas and modes of sHSA deformation. Sensor inlets may be formed into the sHSA structure 720 allowing fluidic connection to the sensors 722. In FIG. 7B, only one sensor inlet 726a is visible. The bending sHSA structure 720 has constraint features 730 that interrupt the pattern of “///” (i.e., the unit cells of the repeated pattern making up the HSA lattice, extending up and to the right in FIG. 7B) but interrupting this pattern with “\” features (i.e., sections extending down and to the right in FIG. 7B) to add asymmetry. Of note, constraint features 730 do not extend like the others upon rotation, thereby providing a stiff constraint layer, causing bending to occur.

The concepts and techniques disclosed herein can be used to sensorize HSAs of various designs and dimensions and are not limited to the examples shown in FIGS. 7A and 7B.

FIGS. 7C and 7D illustrate extension tests being performed on an fluidically innervated sHSA structure 740, which may be the same as or similar to either of the sHSA structures shown in FIGS. 7A and 7B. In FIGS. 7C and 7D, flexible tubing 742 can be seen attached to sensor inlets of the sHSA structure 700. The other ends of flexible tubing 742 can be attached to pressure transducers (not shown).

The extension tests can be performed by a mechanical testing assembly 744 having a bottom attachment 746 that does not permit rotation of the sHSA structure 740 and a top attachment 748 that does permit rotation. FIG. 7C shows a 0 mm extension of the sHSA structure 740 and FIG. 7D shows a 50 mm extension of the sHSA structure 740. The mechanical testing assembly 744 be used to step the extension distance at fixed intervals (e.g., 1 mm or 20 mm intervals) and to obtain measurements of force exerted on the compression testing apparatus 514 by the extended structure 730 (“extension force”).

FIG. 7E showing extension force and voltage change measurements that can be obtained during the extension tests of FIGS. 7C and 7D on a sHSA structure having three sensors (e.g., a “Full,” “Half,” and “Quarter” sensor such as shown in FIG. 7A). A first plot 750 shows extension force versus extension distance. A second plot 752 shows voltage change, ΔV, for the Full 754a, Half 754b, and Quarter 754c sensors versus extension distance. In this example, the sensors 754a-754c may have a diameter of around 1.5 mm. In the figures, error bands represent standard deviation (n=3). Triangles pointing upwards and downwards represent data points during extension from 0 to 50 mm and from 50 to 0 mm, respectively.

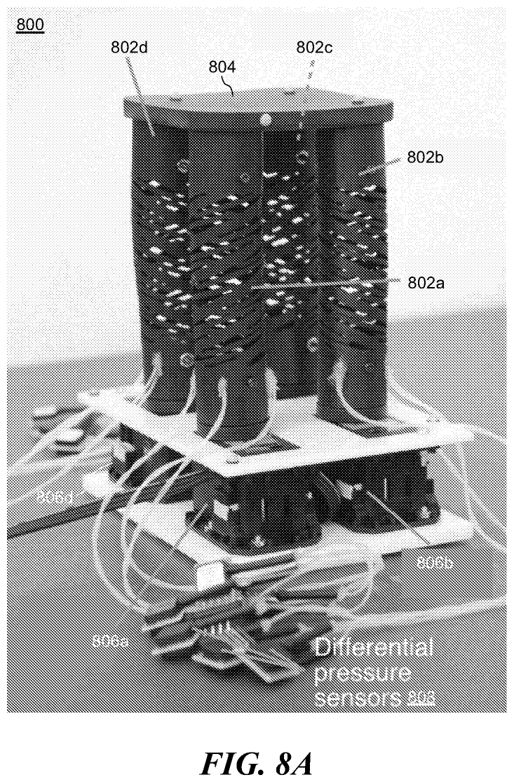

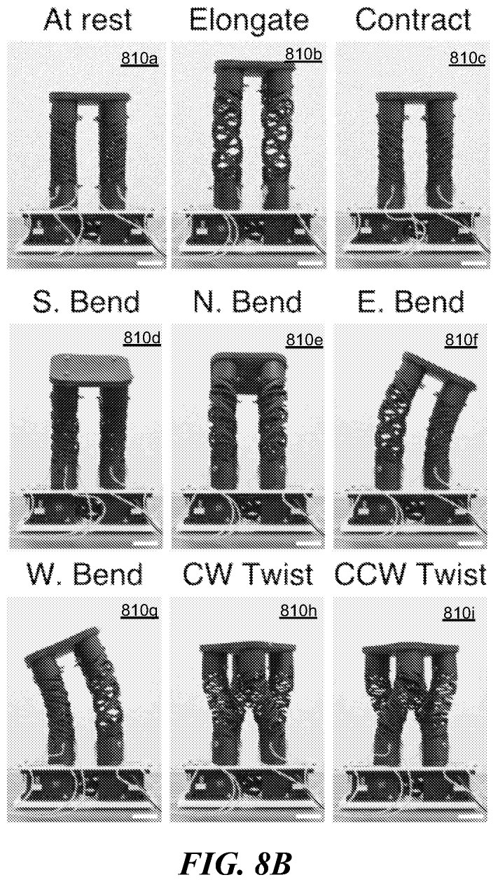

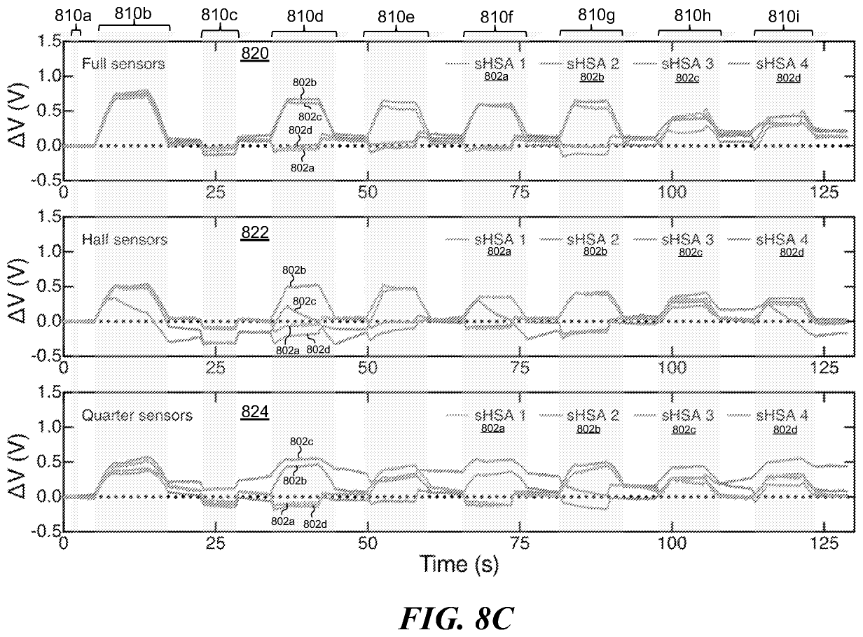

FIG. 7F shows a soft robotic actuator 760 comprised of two bending sHSA structures 762 of opposite handedness in an at-rest configuration and FIG. 7G shows them in a bent configuration (with only one sHSA structures visible in the views of FIGS. 7F and 7G). The soft robotic actuator 760 may be used, for example, as a soft robotic finger. Each of the sHSA structures 762 may be the same or similar to sHSA structure 720 of FIG. 7B. The actuator 760 further includes one or more servos 764 configured to rotate bottom portions 766 of the sHSA structures 762, causing the sHSA structures 762 to bend according to their handedness. The structures and techniques disclosed herein can be used to sensorize various types of soft robotic actuators, such as fingers, hands, etc. For example, the 4 degree of freedom robotic platform show in FIG. 8A could form the basis for a human-style wrist or, if placed upside down, could serve as robotic legs. As another example, the straight sHSAs (FIG. 7A) may be used for linear actuators, such as in applications where extension is needed, like a scissor lift.

FIG. 7H shows servo input and corresponding voltage change measurements that can be obtained as the soft robotic actuator 760 of FIG. 7F undergoes three actuation cycles. A first plot 770 shows servo input (e.g., numbers of pulses) over time and a second plot 772 shows ΔV over the same time for ¾, ½, and ¼ sensors in L- and R-handed sHSAs (1 mm sensor diameters, bottom) as the actuator 760 undergoes three actuation cycles. In more detail, plot line 774a corresponds to the ¾ L-handed sensor, line 774b corresponds to the ½ L-handed sensor, line 774c corresponds to the ¼ L-handed sensor, line 776a corresponds to the ¾ R-handed sensor, line 776b corresponds to the ½ R-handed sensor, and line 776c corresponds to the ¼ R-handed sensor.

Using the test approach described above in conjunction with FIGS. 7C-7H, the inventors have characterized the fluidic sensor responses embedded in straight sHSAs (FIG. 7A) via cyclic tensile extension. sHSA extension yielded increasing ΔV for the Full and Half sensors (with 1.5 mm diameters, FIG. 7E). As the sensors' diameters were increased, increasing sensitivity was observed from the Full and Half sensors. This is expected because larger sensor volumes provide larger pressure changes during identical deformations. Similarly, the Quarter sensor's relatively small volume leads to negligible sensitivity during linear extension in all cases. Following an analogous investigation, the inventors found that a sensor diameter of 1 mm is appropriate for bending sHSAs given the reduced width of their widest struts (FIG. 7B). Next, the inventors used two oppositely handed bending sHSAs and constructed the soft robotic actuator 760 shown in FIGS. 7F and 7G. While the sensors in this device have relatively small volume (e.g., compared to the fluidic sensors in the lattice structures previously described), FIG. 7H demonstrates that there is agreement is seen between servo input and V for at least the ¾ and ½ sensors, which have larger volume than the ¼ sensor.

In some embodiments, a sHSA structure may have design parameters selected from Table 2.

TABLE 2

| sHSA Design, | Fluidic | Sensor | Fluidic Sensor | Differential |
|---|---|---|---|---|
| (Fluidic Sensor | Sensor | Length | Volume | Pressure Sensor |
| Diameter) | ID | (mm) | (mm³) | Range (in H₂0) |
| Straight | Full | 139 | 62 | 0-1 |
| (0.75 mm) | Half | 73 | 32 | 0-1 |
| | Quarter | 41 | 18 | 0-0.05 |
| Straight | Full | 139 | 109 | 0-1 |
| (1 mm) | Half | 73 | 57 | 0-1 |
| | Quarter | 41 | 32 | 0-0.05 |
| Straight | Full | 139 | 171 | 0-1 |
| (1.25 mm) | Half | 73 | 89 | 0-1 |
| | Quarter | 41 | 51 | 0-0.05 |
| Straight | Full | 139 | 246 | 0-1 |
| (1.5 mm) | Half | 73 | 128 | 0-1 |
| | Quarter | 41 | 73 | 0-0.05 |
| Straight | Full | 139 | 335 | 0-1 |
| (1.75 mm) | Half | 73 | 175 | 0-1 |
| | Quarter | 41 | 99 | 0-0.05 |
| Bending | Full | 114 | 90 | 0-1 |
| (1 mm) | Half | 71 | 56 | 0-1 |
| | Quarter | 51 | 50 | 0-0.05 |

Learning Kinematics of sHSA-Based Soft Robots

Turning to FIG. 8A, the concepts and techniques disclosed herein can be used to develop sensorized versions of electrically-driven, sHSA-based soft robots. As an example, a soft robotic platform can be sensorized, according to some embodiments. The platform is based on past designs for soft robotic platforms having four degrees-of-freedom (DOFs), but with the additional of fluidic sensors disclosed herein. See, e.g., L. Chin, J. Lipton, R. MacCurdy, J. Romanishin, C. Sharma, D. Rus, in 2018 IEEE-RAS International Conference on Soft Robotics (RoboSoft) (2018).

FIG. 8A shows a sensorized soft robot system 800 having a platform 804 supported by four straight sHSAs 802a, 802b, 802c, 802d each with 1.5 mm-diameter Full, Half, and Quarter fluidic sensors. The system 800 further includes four servo motors to actuate different ones of the sHSAs 802a, 802b, 802c, 802d, with neighboring sHSAs having opposite handedness. Only three servo motors 806a, 806b, and 806d are visible in FIG. 8A. The system 800 possesses a total of twelve (12) fluidic sensors and four servos for actuation. Each of the fluidic sensors 802 can be connected to a corresponding pressure transducer 808 to obtain twelve (12) different output signals. FIG. 8B shows the sensorized soft robot system 800 in nine distinct postures 810a-810i.

FIG. 8C shows fluidic sensor responses (represented as changes in the voltage changes, ΔV, over time) that may be obtained as the system 800 as it moves between the nine postures 810a-810i (FIG. 8B). A first plot 820 shows responses of the four full sensors, a second plot 822 shows responses of the four half sensors, and a third plot 824 shows responses of the four quarter sensors, all over the same time period. The four sHSAs 802a-802d from FIG. 8A are represented as four different plot lines in each of the plots 820, 822, 824. As illustrated by FIG. 8C, different postures may result in fluidic sensors responses, allowing for proprioceptively determining shape or kinematics in soft sensorized robots.

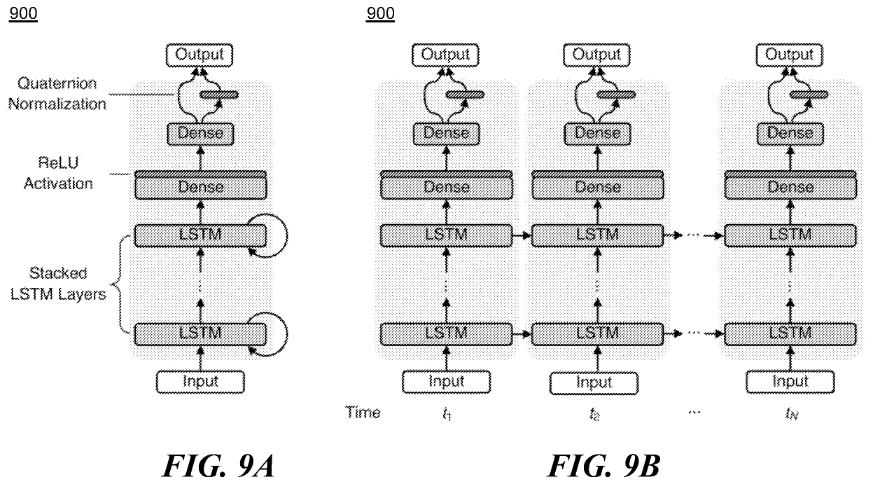

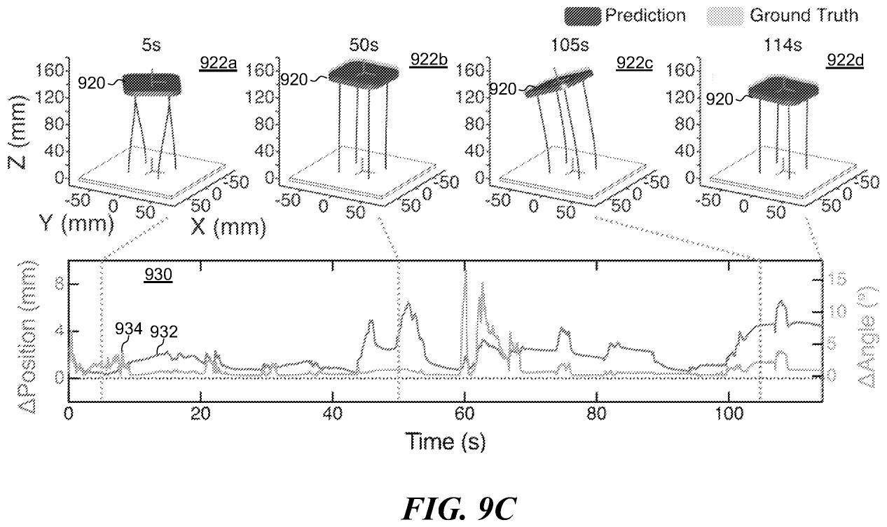

Turning to FIGS. 9A and 9B, according to embodiments of the present disclosure, machine learning (ML) can be employed for proprioception of sHSA-based soft robots. To estimate the forward kinematics of a sHSA-based soft robot, a neural network that predicts its pose (i.e., position and orientation) solely using analog voltage readings from the fluidic sensors as input is provided. Since time-dependent effects like stress relaxation and creep are inherent to viscoelastic materials used for the HSAs, the input-output relation can be modeled with long-short-term-memory networks (LSTMs), a class of neural networks commonly used for learning-based proprioception in soft robotics because of their ability to capture temporal relations.

FIG. 9A shows a network architecture 900 that can be used for proprioception of sHSA-based soft robots, according to some embodiments. A 12-dimensional input (i.e., 12 fluidic sensor readings) is passed through stacked long-short-term-memory networks (LSTM) layers, where number of layers and size of their hidden and cell states are tunable hyperparameters. A dense layer with equal size is followed 5 by ReLU activation and another dense layer that outputs a 7-dimensional vector. This vector is passed through a layer that normalizes the four values corresponding to the quaternion outputs. Dropout (e.g., with probability 0.2) can be applied to the first dense layer and each LSTM layer (not shown). FIG. 9B is another view of the network architecture 900, showing forward pass unrolled through time for input sequence of length N. It should be understood that network architecture 900 is merely illustrative and not intended to limit the scope of the protection sought herein.

Of note, unlike other data-driven sensing pipelines based on soft sensors with time-varying, hysteretic behaviors that require neural networks with large numbers of hidden layers, techniques disclosed herein can achieve accurate pose predictions of an sHSA platform with a relatively simple network architecture.

To train, test, and validate ML-based proprioception of sHSA-based soft robots, data can be collected while driving the platform through a series of motions while simultaneously recording sensor values against a motion capture ground truth. To this end, a sHSA-based robot can be actuated through a sequence of motions, returning to its neutral position after each one. For example, in the case of robot system 800 of FIG. 8A, the motions can include: extension, compression, bend left, bend right, bend forward, bend backward, clockwise twist, and counter clockwise twist. During validation, all of the motions may be performed, but the order in which they are performed is randomized.

During these trials, output voltage signals from differential pressure sensors can be recorded by a digital acquisition unit (e.g., NI USB-6212 DAQ, National Instruments) using software (e.g., MATLAB, Mathworks). The software can also directly records servo position feedback from the servos (e.g., Dynamixel MX-28 servos, ROBOTIS). Ground truth readings can be recorded through rigid body motion tracking (e.g., using Motive, Optitrack). Data can be synchronized via the interpolation of timestamps associated with each measurement, resulting in a final sampling frequency of, for example, 15 Hz. To normalize across trials, the initial sensor measurement for each trial can be recorded as 0 V, so further sensor readings are reported as the pressure difference in the fluidic sensors.

To add variance across trials, a specific servo velocity, extent of motion range, and end-of-movement hold time are chosen from a pre-selected list of options. This causes each trial to be of different lengths, making it harder for the neural network to track spurious patterns. For example, a faster servo velocity may result in the sequence being completed in less time. In some cases, one of the following servo speeds may be used: 5, 10, 20, or 40 rev/min. The hold time can be, for example, 0, 5, or 10 seconds. In some cases, the range fractions studied can include, for example, 25%, 50%, 75% and 100% of full DOF range. For each given velocity, range and hold time, multiple trials (e.g., 5 trials) can be conducted.

Many such trials (e.g., 240 trials) can be conducted over a given time period (e.g., a 7 hour period). The resulting dataset can be used for the neural network training, testing and validation. The dataset can be partitioned into a test set, a training set, and a validation set.

FIG. 9C illustrates how postures of a sHSA-based soft robot that can be predicted using disclosed structures and techniques. A sHSA-based soft robot 920 is controlled through an actuation sequence including postures 922a, 922b, 922c, and 922d (922 generally). For each posture 922, FIG. 9C shows a ML model-predicted pose along with the ground truth pose. It should be understood that these are just static snapshots for the purpose of illustration. During operation, the disclosed ML modeling techniques can be run continuously to model the state as the robot system moves between poses, for example.

FIG. 9C also includes corresponding plot 930 of the position (A Position, line 932) and orientation (A Angle, line 934) error of the over time. In more detail, plot 930 shows Euclidean distance (i.e., position) error and rotational angle error over the course of representative time series. In general, it can be seen that kinematic predictions align well with ground truth, particularly when soft robot motion is more continuous and holding of a pose is minimized. Regarding the prediction data shown in FIG. 9C, it is noted that the rest length of the sHSA platform is 120 mm, and the maximum vertical extension is approximately 40 mm. The overall position error plot 930 is small compared to these lengths. Thus, it is demonstrated that the disclosed motorized sHSAs and fluidic sensing strategies can provide robust actuation and perception capabilities in soft robotics.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A device comprising:
a sensorized structure having a plurality of distributed fluidic networks; and
a plurality of pressure transducers connected to respective ones of the distributed fluidic networks via air tight connectors, the pressure transducers generating output signals responsive to deformation of the sensorized structure.

2. The device of claim 1, wherein the sensorized structure includes a cubic lattice structure.

3. The device of claim 1, wherein the sensorized structure is a body-centered cubic (BCC) lattice structure.

4. The device of claim 1, wherein the sensorized structure includes an octahedral lattice structure.

5. The device of claim 1, wherein the sensorized structure includes a handed shearing auxetic (HSA) structure.

6. The device of claim 1, wherein the air tight connectors comprise elastomeric tubing.

7. The device of claim 1, wherein the pressure transducers comprise differential pressure transducers.

8. The device of claim 1, wherein the sensorized structure comprises a single build material.

9. The device of claim 8, wherein the single build material comprises a photopolymer resin.

10. A method comprising:
forming a sensorized structure with a plurality of distributed fluidic networks;
aspirating non-polymerized resin from within the fluidic networks;
curing the sensorized structure; and
connecting the fluidic networks to pressure transducers via air tight connectors.

11. The method of claim 10, wherein forming the sensorized structure includes 3D printing the structure from a single build material.

12. The method of claim 11, wherein the single build material comprises a photopolymer resin.

13. The method of claim 10, wherein 3D printing the structure includes using digital light processing (DLP).

14. The method of claim 10, wherein forming the sensorized structure includes forming a lattice structure.

15. The method of claim 10, wherein forming the sensorized structure includes forming handed shearing auxetic (HSA) structure.
